(19) United States
(12) Patent Application Publication
(10) Pub. No.: US 2026/0329203 A1
(43) Pub. Date: Oct. 22, 2026

(54) IMAGE FORMING APPARATUS

(71) Applicant: CANON KABUSHIKI KAISHA, Tokyo (JP)

(72) Inventors: TAKESHI KOZUMA, Ibaraki (JP); KENICHI TANAKA, Ibaraki (JP); TAKUYA HASEGAWA, Tokyo (JP); RIKIYA TAKEMASA, Chiba (JP); TATSUO YASUI, Tokyo (JP); MASAKI FURUTANI, Chiba (JP)

(21) Appl. No.: 19/635,943

(22) Filed: Apr. 1, 2026

(30) Foreign Application Priority Data
Apr. 16, 2025 (JP) 2025-067787
Mar. 26, 2026 (JP) 2026-052518

(51) Int. Cl. G03G 15/08; G03G 21/10; G03G 21/20; G03G 21/12

(52) U.S. Cl. CPC G03G 15/0896; G03G 21/105; G03G 21/20; G03G 21/12

(57) ABSTRACT

An image forming apparatus includes an image forming portion including at least one discharging portion; a fixing device including a rotatable heating member; a pipe passage through which residual toner discharged from the at least one discharging portion passes; a cover member provided between the pipe passage and the fixing device, and made of metal; and a latent heat storage material provided between the cover member and the pipe passage. The pipe passage is provided above the rotatable heating member in a vertical direction. The rotatable heating member, the cover member, and the latent heat storage material are disposed in positions crossing at least one plane of planes parallel to a widthwise direction of the rotatable heating member and parallel to the vertical direction.

### BACKGROUND

### FIELD OF THE TECHNOLOGY

The present disclosure relates to an image forming apparatus provided with a fixing device for fixing a toner image on a recording material.

### DESCRIPTION OF THE RELATED ART

An image forming apparatus such as a printer using an electrophotographic system has, for example, a constitution including a collecting pipe passage provided with a plurality of branch pipe passages connected to a plurality of discharging portions, respectively, from which residual toner (waste toner) is discharged, and provided with a merging pipe passage connected to the plurality of branch pipe passages. The plurality of discharging portions include, for example, cleaning devices for collecting residual toner from a photosensitive member and an intermediary transfer belt, or a developing device, and the like. The residual toner discharged from each of the plurality of discharging portions passes through an associated branch pipe passage and is moved to the merging pipe passage. The residual toner moved to the merging pipe passage is conveyed by a screw conveying mechanism, and is collected into a common residual toner container. Further, in the image forming apparatus, a fixing device in which a recording material on which toner is transferred is heated and pressed and then the toner image is fixed on the recording material is provided.

In such an image forming apparatus, in the case where the collecting pipe passage is disposed within a range in which the collecting pipe passage is influenced by heat from the fixing device, there is possibility that the softened toner is deposited and melted on a pipe wall or the like of the collecting pipe passage and thus constitutes a hindrance to conveyance of the residual toner.

On the other hand, in Japanese Laid-Open Patent Application (JP-A) No. 2010-91750, a constitution including a duct provided so as to have a double pipe structure around a collecting pipe passage and including a fan for exhausting air, increased in temperature in the duct, to an outside of a casing of an image forming apparatus is disclosed.

With speed-up of image formation of the image forming apparatus, there is a tendency that a heat quantity of heat generated from the fixing device is increased. On the other hand, in order to meet a demand of downsizing of the image forming apparatus, it becomes difficult to ensure a sufficient distance between the collecting pipe passage and the fixing device in some instances. When the collecting pipe passage and the fixing device are close to each other, there is a possibility that the toner is softened by heat imparted from the fixing device to the residual toner contacting the pipe wall of the collecting pipe passage and is deposited and melted on the pipe wall of the collecting pipe passage, and thus a phenomenon such that the residual toner is clogged in the collecting pipe passage occurs.

As a countermeasure against this phenomenon, as described in JP-A No. 2010-91750, it would be considered that a heat exhaust duct for forming an air layer is provided between the collecting pipe passage and the fixing device and by a heat exhausting fan, airstream is forced formed from an outside of the heat exhaust duct, and thus the heat is discharged.

However, in the case of such a constitution, a heat exhausting effect cannot be achieved when an operation of the heat exhausting fan is stopped. For example, in the case where a power source of the image forming apparatus is turned off immediately after a print job is executed, or the like case, the heat exhausting fan is stopped in a state in which ambient air around the fixing device accumulates heat by the operation of the fixing device in the print job. In such a case, there is a possibility that fusion of the toner occurs in the collecting pipe passage.

### SUMMARY

The present disclosure is directed to suppress that residual toner is clogged in a pipe passage, through which the residual toner passes, due to the influence of heat from a fixing device.

According to an aspect of the present disclosure is to provide an image forming apparatus comprising: an image forming portion including at least one discharging portion for discharging residual toner and configured to form a toner image on a recording material; a fixing device including a rotatable heating member for imparting heat to the recording material and configured to fix, to the recording material, the toner image formed by the image forming portion; a pipe passage through which the residual toner discharged from the at least one discharging portion passes; a cover member provided between the pipe passage and the fixing device, and made of metal; and a latent heat storage material provided between the cover member and the pipe passage, wherein the pipe passage is provided above the rotatable heating member in a vertical direction, and wherein the rotatable heating member, the cover member, and the latent heat storage material are disposed in positions crossing at least one plane of planes parallel to a widthwise direction of the rotatable heating member and parallel to the vertical direction.

Features of the present disclosure will become apparent from the following description of embodiments with reference to the attached drawings. The following description of embodiments are described by way of example.

### BRIEF DESCRIPTION OF THE DRAWINGS

FIG. 1 is a schematic sectional view of an image forming apparatus.

FIG. 2 is a schematic sectional view of a fixing device.

FIG. 3 is a schematic perspective view of a residual toner collecting device.

FIG. 4 is a schematic sectional view of a collecting pipe passage.

FIG. 5 is a schematic sectional view (X-Y cross-sectional view) showing a positional relationship between the collecting pipe passage and the fixing device.

FIG. 6 is a schematic sectional view (Y-Z cross-sectional view) showing a positional relationship between the collecting pipe passage and the fixing device.

### DESCRIPTION OF THE EMBODIMENTS

In the following, an image forming apparatus according to the present disclosure will be described further specifically with reference to the drawings.

### Embodiment 1

### Image forming apparatus

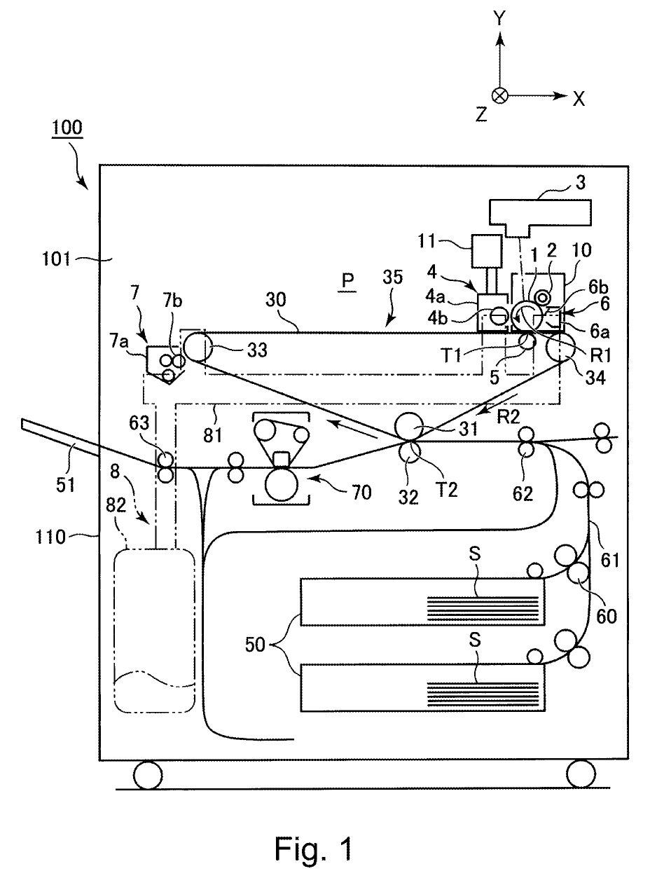

FIG. 1 is a schematic sectional view of an image forming apparatus 100 of this embodiment. The image forming apparatus 100 of this embodiment is a digital printer which is capable of forming an image of black (K) on a sheet-like recording material S by using an electrophotographic process and which employs an intermediary transfer type. The image forming apparatus 100 is, for example, capable of forming the image on the basis of image information sent from an external device such as a personal computer connected to the image forming apparatus 100.

Incidentally, the image forming apparatus 100 will be described on the assumption that the image forming apparatus 100 is installed on a horizontal plane.

Arrangements and directions of respective members in the image forming apparatus 100 described in the following are those in the case where the image forming apparatus 100 was installed on the horizontal plane. For the image forming apparatus 100 and elements thereof, in FIG. 1, a front side on the drawing sheet is a "front (front surface)" side, a rear side on the drawing sheet is a "rear (rear surface)" side, a right-hand side is a "right" side, and a left-hand side is a "left" side. A direction (front-rear direction) perpendicular to the drawing sheet of FIG. 1 in which a front side and a rear side of the image forming apparatus 100 are connected is substantially parallel to a rotational axis direction of a photosensitive drum 1 described later and a rotational axis direction of a stretching roller of an intermediary transfer belt 30 described later. In some instances, description is made by defining a left-right direction (i.e., horizontal direction) in FIG. 1 as an X axis direction, an up-down direction (i.e., gravitation direction (vertical direction)) in FIG. 1 as a Y axis direction, and a direction perpendicular to both the X axis direction and the Y axis direction (i.e., the front-rear direction) as a Z axis direction. Further, although the up-down direction refers to up and down (upper and lower) in the gravitation direction (vertical direction), the up-down direction does not mean only just above (on) and just below (under), but includes an upper side and a lower side than a horizontal plane passing through a position of interest or an elements of interest.

The image forming apparatus 100 includes an image forming portion P for forming the image of black (K) on the recording material S. In this embodiment, the image forming portion P is constituted by including the photosensitive drum 1, a charging roller 2, an exposure device 3, a developing device 4, a drum cleaning device 6, a developer supplying device 11, an intermediary transfer unit 35, an outer secondary transfer roller 32, and the like.

The photosensitive drum 1 which is a rotatable drum-shaped (cylindrical) photosensitive member (electrophotographic photosensitive member) as a first image bearing member is rotated in an arrow R1 direction (counterclockwise direction) in FIG. 1. A surface of the rotating photosensitive drum 1 is electrically charged uniformly to a predetermined potential of a predetermined polarity (negative polarity in this embodiment) by the charging roller 2 which is a roller-shaped charging member as a charging means. During charging, to the charging roller 2, a charging voltage (charging bias) including a DC component of the same polarity as a charge polarity of the photosensitive drum 1 is applied. The charged surface of the photosensitive drum 1 is scanned with and exposed to light depending on the image information (image signal) by the exposure device 3 as n exposure means, so that an electrostatic latent image (electrostatic image) depending on the image information is formed on the photosensitive drum 1.

The electrostatic latent image formed on the photosensitive drum 1 is developed (visualized) by being supplied with toner by the developing device 4 as a developing means, so that a toner image (toner picture, developer image) is formed on the photosensitive drum 1. In this embodiment, the developing device 4 uses a two-component developer containing toner (non-magnetic toner particles) as a developer and a carrier (magnetic carrier particles). The developing device 4 includes a developing container 4a for accommodating the developer and a developing sleeve 4b, as a developer carrying member (developing member), rotatably supported by the developing container 4a. The developing sleeve 4b conveys the developer toward the photosensitive drum 1 by being rotated while carrying the developer. The developing device 4 supplies the toner from the developer carried on the developing sleeve 4b to the photosensitive drum 1 depending on the electrostatic latent image on the photosensitive drum 1. During development, to the developing sleeve 4b, a developing voltage (developing bias) including a DC component of the same polarity (negative polarity in this embodiment) as the charge polarity of the photosensitive drum 1 is applied. In this embodiment, on an exposed portion of the photosensitive drum 1 lowered in absolute value of potential by exposure after the photosensitive drum surface is uniformly charged, the toner charged to the same polarity as the charge polarity of the photosensitive drum 1 is developed (reverse development type). In this embodiment, a normal charge polarity of the toner, which is a main charge polarity of the toner during the development is the negative polarity.

The intermediary transfer belt 30, as a second image bearing member, which is an intermediary transfer member constituted by an endless belt is disposed so as to oppose the photosensitive drum 1. The intermediary transfer belt 30 is stretched by, as a plurality of stretching rollers, an inner secondary transfer roller 31, a tension roller 33, and a driving roller 34. The intermediary transfer belt 30 is rotated (circulated and moved) in an arrow R2 direction (clockwise direction) in FIG. 1 by rotationally driving the driving roller 34. On an inner peripheral surface side of the intermediary transfer belt 30, in a position opposing the photosensitive drum 1, a primary transfer roller 5 which is a roller-shaped primary transfer member as a primary transfer means is provided. The primary transfer roller 5 is pressed toward the photosensitive drum 1 and forms a primary transfer portion (primary transfer nip) T1 which is a contact portion between the photosensitive drum 1 and the intermediary transfer belt 30. The stretching rollers other than the driving roller 34, and the primary transfer roller 5 are driven with rotation of the intermediary transfer belt 30. The toner image formed on the photosensitive drum 1 is transferred (primary transferred) in the primary transfer portion T1 onto the rotating intermediary transfer belt 30 under application of a predetermined pressing force and an electrostatic load bias by the primary transfer roller 5. During primary transfer, to the primary transfer roller 5, a primary transfer voltage (primary transfer bias) of an opposite polarity (positive polarity in this embodiment) to the normal charge polarity of the toner is applied. Toner (residual toner, transfer residual toner) remaining on the photosensitive drum 1 without being transferred onto the intermediary transfer belt 30 during the primary transfer is removed and collected from the photosensitive drum 1 by the drum cleaning device 6 as a photosensitive member cleaning means. Further, a developer for supply, containing toner in an amount corresponding to an amount of the toner consumed from the developing device 4 is supplied from the developer supplying device 11 to the developing device 4.

On an outer peripheral surface side of the intermediary transfer belt 30, in a position opposing the inner secondary transfer roller 31 through the intermediary transfer belt 30, an outer secondary transfer roller 32 which is a roller-shaped secondary transfer member as a secondary transfer means is provided. The outer secondary transfer roller 32 is pressed toward the inner secondary transfer roller 31 and forms a secondary transfer portion (secondary transfer nip) T2 which is a cover portion between the intermediary transfer belt 30 and the outer secondary transfer roller 32. To the toner image formed on the intermediary transfer belt 30, in the secondary transfer portion T2, a predetermined pressing force and an electrostatic load bias are applied by the outer secondary transfer roller 32. By this, the toner image on the intermediary transfer belt 30 is transferred (secondarily transferred) onto the recording material S nipped and conveyed by the intermediary transfer belt 30 and the outer secondary transfer roller 32. During secondary transfer, to the outer secondary transfer roller 32, a secondary transfer voltage (secondary transfer bias) of the opposite polarity (positive polarity in this embodiment) to the normal charge polarity of the toner is applied. The inner secondary transfer roller 31 is electrically grounded (connected to the ground potential). Incidentally, a constitution in which a secondary transfer voltage of the same polarity as the normal charge polarity of the toner is applied to a roller corresponding to the inner secondary transfer roller 31 in this embodiment and in which a roller corresponding to the outer secondary transfer roller 32 in this embodiment is electrically grounded may also be employed. Toner (residual toner, transfer residual toner) remaining on the intermediary transfer belt 30 without being transferred onto the recording material S during the secondary transfer is removed and collected from the intermediary transfer belt 30 by the belt cleaning device 7 as an intermediary transfer member cleaning means.

The recording material (transfer material, recording medium, sheet) S such as paper or a plastic sheet is accommodated in the form such that the recording material S is stacked in a cassette 50 as a recording material accommodating portion. This recording material S is sent from the cassette 50 at an image forming timing by a feeding roller 60 or the like which is a feeding member as a feeding embodiment. This recording material S discharges through a conveying path 61 and is conveyed toward a registration roller 62 which is a conveying member as a conveying means. The registration roller 62 corrects inclination of the conveyed recording material S, and thereafter conveys the recording material S at a predetermined timing toward the secondary transfer portion T2 in synchronism with toner image formed on the intermediary transfer belt 30.

The recording material S on which the toner image is transferred is conveyed toward a fixing device 70 as a fixing means. The fixing device 70 heats and presses the recording material S on which an unfixed toner image is carried and fixes (melts, sticks) the toner image on the recording material S. Here, in order to achieve further high productivity of the image forming apparatus, it is required to impart a heat quantity, necessary to melt the toner image in a short time, to the toner image on the recording material S.

For that reason, there is a constitution in which the toner image is fixed between a fixing belt constituted by an endless belt and a pressing member such as a pressing roller or the like contacting an outer peripheral surface of the fixing belt. In this embodiment, the fixing device 70 fixes the toner image on the recording material S by a predetermined pressing force by the fixing belt and the pressing roller which nip and convey the recording material S and by heating with a heat source such as a halogen heater (belt heating type). This fixing device 70 form a relatively wide fixing nip by using a pad member nipping the fixing belt between itself and the pressing roller, and a heating time of the recording material S is made long, so that the toner image can be fixed on the recording material S even when a conveying speed of the recording material S is fast. Details of the fixing device 70 will be described later.

The recording material S subjected to fixing (process) of the toner image by the fixing device 70 is discharged (output) onto a discharge tray 51 as a recording material discharge portion provided outside a casing 110 of the image forming apparatus 100 by a discharging roller 63 or the like as a recording material discharging member.

In this embodiment, the photosensitive drum 1, the charging roller 2, and the drum cleaning provided 6 integrally constitute a drum cartridge 10 detachably mountable to an apparatus main body 101 of the image forming apparatus 100. Further, in this embodiment, the developing device 4 constitutes a developing cartridge detachably mountable to the apparatus main body 101 of the image forming apparatus 100 substantially singly. Further, in this embodiment, the intermediary transfer belt 30, the stretching rollers for the intermediary transfer belt 30, the primary transfer roller 5, and the belt cleaning device 7 integrally constitute the intermediary transfer unit 35 detachably mountable to the apparatus main body 101 of the image forming apparatus 100.

Further, the toner removed from the photosensitive drum 1 by the drum cleaning device 6 and the toner removed from the intermediary transfer belt 30 by the belt cleaning device 7 are collected by a residual toner collecting device 8. Details of the residual toner collecting device 8 will be described later.

### Cleaning device

Next, the cleaning devices (drum cleaning device 6, belt cleaning device 7) in this embodiment will be further described.

As shown in FIG. 1, with respect to a rotational direction (surface movement direction) of the photosensitive drum 1, the drum cleaning device 6 is disposed downstream of the primary transfer portion T1 (and upstream of a charging portion by the charging roller 2). The drum cleaning device 6 includes a drum cleaning container 6a and a cleaning blade 6b as a cleaning member. The cleaning black 6b is mounted to the drum cleaning container 6a so as to contact the surface of the photosensitive drum 1. The drum cleaning device 6 rubs the surface of the rotating photosensitive drum 1 by the cleaning blade 6b. By this, the drum cleaning device 6 removes the residual toner, paper powder, an external additive, and the like, which passes through the primary transfer portion T1 and which are deposited on the surface of the photosensitive drum 1, from the surface of the photosensitive drum 1, and then collects these substances in the drum cleaning container 6a.

Further, as shown in FIG. 1, with respect to a rotational direction (surface movement direction) of the intermediary transfer belt 30, the belt cleaning device 7 is disposed downstream of the secondary transfer portion T2 (and upstream of the primary transfer portion T1). In this embodiment, the belt cleaning device 7 is disposed in a position opposing the tension roller 33 through the intermediary transfer belt 30. The belt cleaning device 7 cleans an image forming surface of the intermediary transfer belt 30. The belt cleaning device 7 includes a belt cleaning container 7a and a cleaning brush 7b as a cleaning member. The cleaning brush 7b is rotatably supported by the belt cleaning container 7a so as to be rotated in contact with the surface of the intermediary transfer belt 30. The belt cleaning provided 7 rubs the surface of the rotating intermediary transfer belt 30 by the cleaning brush 7b. By this, the belt cleaning device 7 removes the residual toner, the paper powder, and the external additive, and the like, which passes through the secondary transfer portion T2 and which are deposited on the surface of the intermediary transfer belt 30, from the surface of the intermediary transfer belt 30, and then collects these substances in the belt cleaning container 7a. Incidentally, the belt cleaning device 7 may also have a constitution including a cleaning blade, as the cleaning member, provided so as to contact the surface of the intermediary transfer belt 30.

Here, the residual toner, the paper powder, the external additive, and the like which are collected by the drum cleaning device 6 and the belt cleaning device 7 are also referred to as "residual (waste) particles" or "residual (waste) toner".

### Fixing device

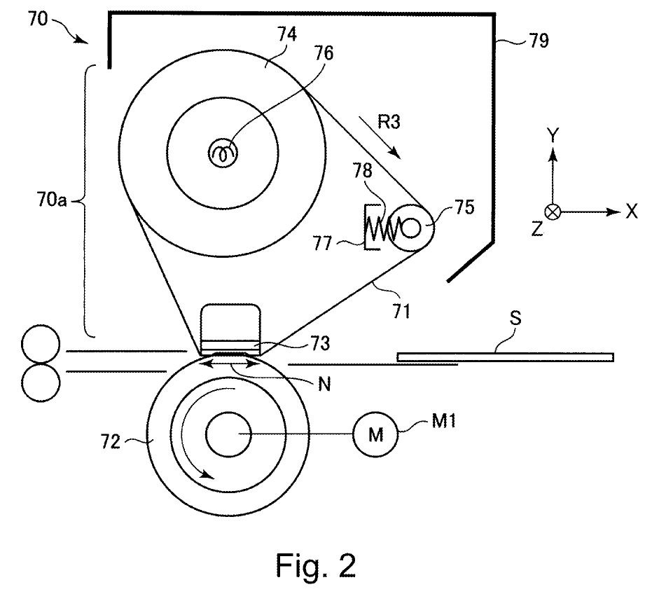

Next, the fixing device 70 in this embodiment will be further described. FIG. 2 is a schematic sectional view of the fixing device 70 in this embodiment (shows a cross section substantially perpendicular to a rotational axis direction of the photosensitive drum 1).

The fixing device 70 includes a heating unit 70a for imparting heat to the recording material S. The heating unit 70a includes a fixing belt 71 constituted by a rotatable endless belt as a rotatable heating member, a pad 73 as a fixing member, a heating roller 74 as a heating member, a halogen heater 76, and a steering roller 75 as a tension imparting member. Further, the fixing device 70 includes a pressing roller 72, as a rotatable pressing member, which is disposed opposed to the fixing belt 71 and which form a fixing nip (fixing portion) N in cooperation with the fixing belt 71. Further, the fixing device 70 includes a fixing cover 79.

The fixing belt 71 is a thin cylindrical member having thermal conductivity and heat resistance. In this embodiment, the fixing belt 71 has a three-layer structure including a base layer, an elastic layer formed on an outer periphery of this base layer, and a parting layer formed on an outer periphery of this elastic layer. In this embodiment, the base layer is 60 μm in thickness, and polyimide resin (PI) is used as a material thereof. Further, in this embodiment, the elastic layer is 300 μm in thickness, and a silicone rubber is used as a material thereof. Further, in this embodiment, the parting layer is 30 μm in thickness, and PFA (tetrafluroethylene-perfluoroalkoxyethylene copolymer) is used as a material thereof. Further, the fixing belt 71 is stretched by the pad 73, the heating roller 74, and the steering roller 75.

The pad 73 is a member for forming the fixing nip N, in which a width thereof in the conveying direction of the recording material S is a predetermined width, by being press-contacted to the pressing roller 72 through the fixing belt 71. In this embodiment, the pad 73 is a member such that a cross section substantially perpendicular to a rotational axis direction of the heating roller 74 is a substantially rectangular shape and that is long along a widthwise direction (direction substantially perpendicular to a surface movement direction) of the fixing belt 71. In this embodiment, as a material of the pad 73, a LCP (liquid crystal polymer) which is a material having heat resistance is used. The pad 73 is supported by a frame or the like of the fixing device 70.

The pressing roller 72 is a roller including a rotation shaft, an elastic layer formed on an outer periphery of this rotation shaft, and a parting layer formed on an outer periphery of this elastic layer. In this embodiment, the rotation shaft is formed of stainless steel. Further, in this embodiment, the elastic layer is 5 mm in thickness, and an electroconductive silicone rubber is used as a material thereof. Further, in this embodiment, the parting layer is 50 μm in thickness, and PFA which is fluorine-containing region is used as a material thereof. The pressing roller 72 is rotatably shaft-supported by a pressing arm (not shown) movably provided to the fixing device 70. To the pressing roller 72, a gear is fixed at one end portion thereof with respect to a rotational axis direction thereof, and the pressing roller 72 is connected to a motor M1 as a driving source through this gear. Further, the pressing roller 72 is rotationally driven by a driving force transmitted from the motor M1. The pressing roller 72 is contacted to the pad 73 through the fixing belt 71, and forms the fixing nip N in cooperation with the fixing belt 71. The fixing belt 71 is rotated (circulated and moved) in an arrow R3 direction (clockwise direction) in FIG. 2 with rotation of the pressing roller 72 by being nipped by the pressing roller 72 and the pad 73.

The heating roller 74 is a roller for heating the fixing belt 71 and is constituted by a hollow pipe. In this embodiment, the heating roller 74 is a pipe made of an aluminum material (aluminum or aluminum alloy) of 1 mm in thickness and about 80 mm in outer diameter. The heating roller 74 is rotatably supported by the frame or the like of the fixing device 70. A rotational axis direction of the heating roller 74 is substantially parallel to the rotational axis direction of the photosensitive drum 1. Inside (in the hollow portion of) the heating roller 74, the halogen heater 76 is disposed. The halogen heater 76 is capable of generating heat up to a predetermined temperature. The fixing belt 71 is heated by the heating roller 74. Incidentally, a temperature (fixing temperature) of the fixing belt 71 is controlled to a predetermined target temperature depending on a kind (paper kind) of the recording material S on the basis of a temperature detection result by a thermistor as a temperature detecting means provided to the fixing device 70.

The steering roller 75 is a roller for imparting tension to the fixing belt 71, and is constituted by a hollow pipe. In this embodiment, the steering roller 75 is constituted by forming a layer of a silicone rubber of 200 μm in thickness on a surface layer of a roller portion made of stainless steel in 20 mm of an outer diameter. The steering roller 75 is rotatably supported by the frame or the like of the fixing device 70 through a bearing and a bush. Further, a pressing spring 78 as a pressing member is supported by a steering frame 77 provided to the fixing device 70. Further, the steering roller 75 is urged toward the fixing belt 71 by that the bush is pressed by the pressing spring 78.

The fixing cover 79 is a cover member provided so as to cover the heating unit 70a as a whole. The fixing cover 79 is provided for preventing heat generated in the heating unit 70a from directly warming an external member of the fixing device 70. The fixing cover 79 is formed of heat-resistant resin such as LCP or PPS (polyphenylene sulfide).

Incidentally, in this embodiment, the fixing device 70 has a constitution in which only the heating unit 70a is provided with the heat source, but can also further have a constitution in which the pressing roller 72 is provided with the heat source. Further, the fixing device 70 may also have a constitution in which recording material S is heated and pressed by nipping and conveying the recording material S by a heating roller as a rotatable heating member provided with a heat source such as a heater and a pressing roller as a rotatable pressing member press-contacted to the heating roller (roller heating type).

### Residual toner collecting device

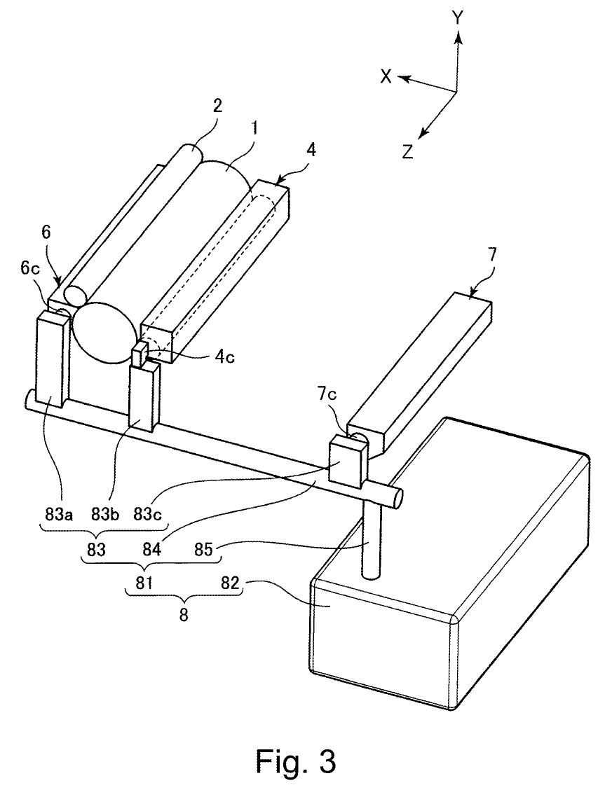

The residual toner collecting device 8 in this embodiment will be described. FIG. 3 is a schematic perspective view of the residual toner collecting device 8 as viewed from an obliquely rear side of the image forming apparatus 100.

The residual toner collecting device 8 is constituted by including a collecting pipe passage (residual toner collecting pipe) 81 and a residual toner container (residual toner collecting container) 82. The collecting pipe passage 81 is constituted by a plurality of branch pipe passages (branch pipes) 83 (first, second, and third branch pipe passages 83a, 83b, and 83c), a merging pipe passage (merging pipe) 84, and a connecting pipe passage (connecting pipe) 85. The residual toner is moved and merged into the merging pipe passage 84 through the plurality of branch pipe passages 83 and is collected from the merging pipe passage 84 toward the residual toner container 82 through the connecting pipe passage 85. The residual toner container 82 is detachably mountable to the apparatus main body 101 of the image forming apparatus 100 and is exchanged with an empty one, for example, in the case where an inside thereof becomes full.

As described above, the residual toner and the like remaining on the photosensitive drum 1 are removed from the photosensitive drum 1 by the drum cleaning device 6 and are accommodated in the drum cleaning container 6a of the drum cleaning device 6. The residual toner and the like accommodated in the drum cleaning container 6a are conveyed as the residual toner rearward by a conveying member (not shown) such as a conveying screw or the like provided inside the drum cleaning container 6a. Then, this residual toner is discharged toward the first branch pipe passage 83a through a first discharge opening 6c provided in a rear-side end portion of the drum cleaning container 6a.

Further, in this embodiment, the developing device 4 uses a two-component developer as the developer, and the toner inside the developing container 4a of the developing device 4 contains not only the toner but also a carrier for charging the toner. Friction is generated by stirring a toner and the carrier, so that the toner is charged by static electricity. The toner is consumed by image formation. Then, a developer for supply containing the toner in an amount corresponding to a consumption amount is newly supplied from the developer supply device 11 to the developing device 4. On the other hand, there is a possibility that the carrier is not consumed by the image formation and therefore is deteriorated by being used for a long term in the developing device 4. Therefore, in this embodiment, the developer containing the deteriorated carrier is discharged from the developing device 4, and the developer for supply containing the carrier in an amount corresponding to the discharged amount is newly supplied from the developer supplying device 11 to the developing device 4. The developer containing the deteriorated carrier is conveyed as the developer rearward by a conveying member (not shown) such as a conveying screw or the like provided inside the developing container 4a. Then, this residual toner is discharged toward the second branch pipe passage 83b through a second discharge opening 4c provided in a rear-side end portion of the developing container 4a.

Further, as described above, the residual toner and the like remaining on the intermediary transfer belt 30 are removed from the intermediary transfer belt 30 by the belt cleaning device 7 and is accommodated inside the belt cleaning container 7a of the belt cleaning device 7. The residual toner and the like accommodated in the belt cleaning container 7a are conveyed as the developer rearward by a conveying member (not shown) such as a conveying screw provided inside the belt cleaning container 7a. Then, this residual toner is discharged toward a third branch pipe passage 83c through a third discharge opening 7c provided in a rear-side end portion of the belt cleaning container 7a.

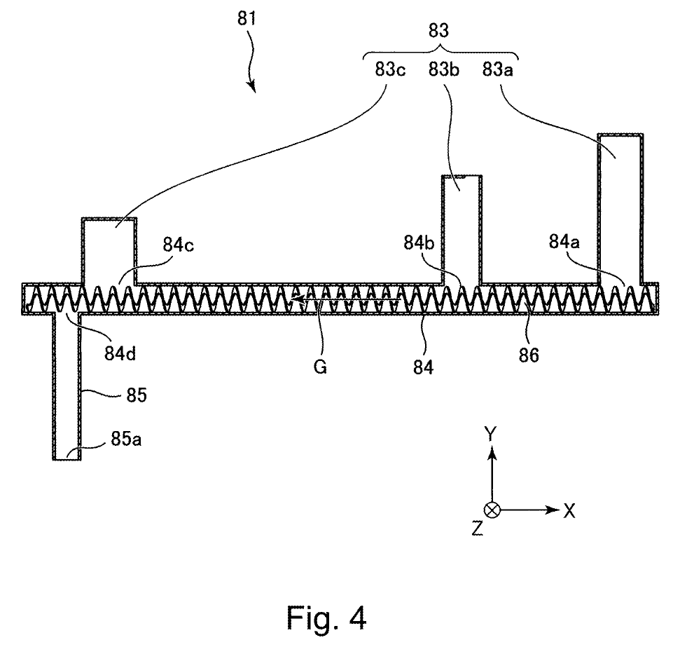

FIG. 4 is a schematic sectional view of the collecting pipe passage 81 in this embodiment (shows a cross section, cut substantially parallel to gravitation direction, as viewed from the front side).

To the first, second, and third branch pipe passages 83a, 83b, and 83c, the merging pipe passage 84 is connected. In this embodiment, the first, second, and third branch pipe passages 83a, 83b, and 83c extend substantially parallel to the gravitation direction. Further, in this embodiment, the merging pipe passage 84 extends in a left-right direction substantially parallel to the horizontal direction. The merging pipe passage 84 communicates with the first branch pipe passage 83a through a first receiving opening 84a. Further, the merging pipe passage 84 communicates with the second branch pipe passage 83b through a second receiving opening 84b. Further, the merging pipe passage 84 communicates with the third branch pipe passage 83c through a third receiving opening 84c. The first, second, and third receiving openings 84a, 84b, and 84c are open upward. In this embodiment, each of the first, second, and third branch pipe passages 83a, 83b, and 83c is not provided with a conveying member (or a loosening (collapsing) member for conveying (or loosening (collapsing)) the residual toner in a period from discharge of the residual toner through an associated one of the first, second, and third discharge openings 6c, 4c, and 7c to merging with the merging pipe passage 84.

Further, in this embodiment, the connecting pipe passage 85 is connected to the merging pipe passage 84. In this embodiment, the connecting pipe passage 85 extends substantially parallel to the gravitation direction. The merging pipe passage 84 communicates with the connecting pipe passage 85 through a drop opening 84d. The drop opening 84d opens downward. Further, to the connecting pipe passage 85, the residual toner container 82 is connected through a connecting opening 85a in an end portion of the connecting pipe passage 85 on a side opposite from the drop opening 84d.

In this embodiment, the first, second, and third discharge openings 6c, 4cc, and 7c are positioned on a rear side in the front-rear direction than the intermediary transfer belt 30 is. Further, in this embodiment, the first, second, and third receiving openings 84a, 84b, and 84c are positioned on a rear side in the front-rear direction than the intermediary transfer belt 30 is. Further, in this embodiment, the drop opening 84d and the connecting opening 85a are positioned on a rear side in the front-rear direction than the intermediary transfer belt 30 is. Further, in this embodiment, the first, second, and third branch pipe passages 83a, 83b, and 83c, the merging pipe passage 84, and the connecting pipe passage 85 are positioned on a rear side in the front-rear direction than the intermediary transfer belt 30 is.

Inside the merging pipe passage 84, a conveying member 86 is provided. In this embodiment, the merging pipe passage 84 is constituted by a circular pipe substantially circular in cross section substantially perpendicular to an axis direction thereof. Further, in this embodiment, the conveying member 86 is constituted by a conveying screw (shaftless screw or the like). The first receiving opening 84ais provided in the neighborhood of an upstream-side end portion of an inside of the merging pipe passage 84 in a conveying direction G of the residual toner by the conveying member 86. The second receiving opening 84b is provided downstream of the first receiving opening 84a in the conveying direction G of the residual toner inside the merging pipe passage 84. Further, the third receiving opening 84c is provided downstream of the second receiving opening 84b in the conveying direction G of the residual toner inside the merging pipe passage 84. Further, the drop opening 84d is provided on a side downstream of the third receiving opening 84c in the conveying direction G of the residual toner inside the merging pipe passage 84 and in the neighborhood of a downstream-side end portion of the inside of the merging pipe passage 84 in the conveying direction G of the residual toner. The conveying member 86 is rotationally driven by a driving force transmitted from a motor (not shown) as a driving source provided to the apparatus main body 101 of the image forming apparatus 100. Incidentally, the drop opening 84d may also be provided, for example, between the second receiving opening 84b and the third receiving opening 84c in the conveying direction G of the residual toner inside the merging pipe passage 84. In this case, the conveying direction of the residual toner by the conveying member 86 may only be required to be made opposite directions between a portion where the residual toner is conveyed from the first and second receiving openings 84a and 84b side toward the drop opening 84d side and a portion where the residual toner is conveyed from the third receiving opening 84c side toward the drop opening 84d side. For example, a winding direction of a blade of a conveying screw, as the conveying member 86, is made an opposite direction thereto, so that the conveying direction of the residual toner can be made an opposite direction thereto.

The residual toner from each of the drum cleaning device 6, the developing device 4, and the belt cleaning device 7 which are as the plurality of discharging portions is discharged to an associated one of the first, second, and third branch pipe passages 83a, 83b, and 83c, respectively, through an associated one of the first, second, and third discharge openings 6c, 4c, and 7c, respectively. The residual toner discharged to an inside of each of the first, second, and third branch pipe passages 83a, 83b, and 83c is dropped inside the associated one of the first, second, and third branch pipe passages 83a, 83b, and 83c by gravitation. The residual toner dropped inside the associated one of the first, second, and third branch pipe passages 83a, 83b, and 83c is moved toward the inside of the merging pipe passage 84 through an associated one of the first, second, and third receiving openings 84a, 84b, and 84c, respectively. The residual toner moved to the inside of the merging pipe passage 84 is conveyed by the conveying member 86 and is moved toward the inside of the connecting pipe passage 85 through the drop opening 84d. The residual toner moved to the inside of the connecting pipe passage 85 is dropped inside the connecting pipe passage 85 by gravitation and is moved to the inside of the residual toner collecting container 82 through the connecting opening 85a, and is accommodated inside the residual toner collecting container 82.

Incidentally, in this embodiment, the first, second, and third branch pipe passages 83a, 83b, and 83c extend substantially parallel to the gravitation direction, but the present disclosure is not limited thereto. At least one of the first, second, and third branch pipe passages 83a, 83b, and 83c may also extend in the up-down direction (direction along the gravitation direction) while being inclined with respect to the gravitation direction within a range in which the residual toner is movable by the gravitation. This angle of the inclination is not limited thereto, but is appropriate in a range of 45° or less with respect to the gravitation direction, typically in a range of 30° or less with respect to the gravitation direction. Further, in this embodiment, the merging pipe passage 84 extends substantially parallel to the horizontal direction, but may also extend along a direction crossing the gravitation direction by being inclined with respect to the horizontal direction within a range in which the conveyance of the residual toner by the conveying member 86 can be appropriately performed. This angle of the inclination is not limited thereto, but is appropriate in a range of 45° or less with respect to the horizontal direction, typically in a range of 30° or less with respect to the horizontal direction. Further, in this embodiment, the connecting pipe passage 85 extends substantially parallel to the gravitation direction, but the present disclosure is not limited thereto, and the connecting pipe passage 85 may also extend in the up-down direction (direction along the gravitation direction) while being inclined with respect to the gravitation direction within a range in which the residual toner is movable by the gravitation. This angle of the inclination is appropriate in a range of 45° or less with respect to the gravitation direction, typically in a range of 30° or less with respect to the gravitation direction. Further, in this embodiment, the collecting pipe passage 81 is constituted by including the connecting pipe passage 85, but the present disclosure is not limited thereto. For example, a constitution in which the collecting pipe passage 81 is not provided with the connecting pipe passage 85 and in which the residual toner container 82 is directly connected to the merging pipe passage 84 may also be employed. Further, in this embodiment, the first, second, and third branch pipe passages 83a, 83b, and 83c, and the merging pipe passage 84 are constituted by separate members, but at least one of the first, second, and third branch pipe passages 83a, 83b, and 83c may also be integrally constituted with the merging pipe passage 84. Further, in this embodiment, the residual toner collecting device 8 includes the conveying member 86 as a conveying means for conveying the residual toner inside the merging pipe passage 84, but the present disclosure is not limited thereto. For example, the residual toner collecting device 8 may also be constituted so as to convey the residual toner inside the merging pipe passage 84 by a flow of air. In this case, the residual toner collecting device 8 is provided with an air blowing means, such as an air pump or a fan, as a conveying means. Further, in this embodiment, the merging pipe passage 84 is constituted by the circular pipe, but a cross-sectional shape of the merging pipe passage 84 is not limited to a circular shape, but may also be, for example, an elliptical shape or a polygonal shape such as a rectangular shape.

### Temperature rise suppression constitution of residual toner collecting device

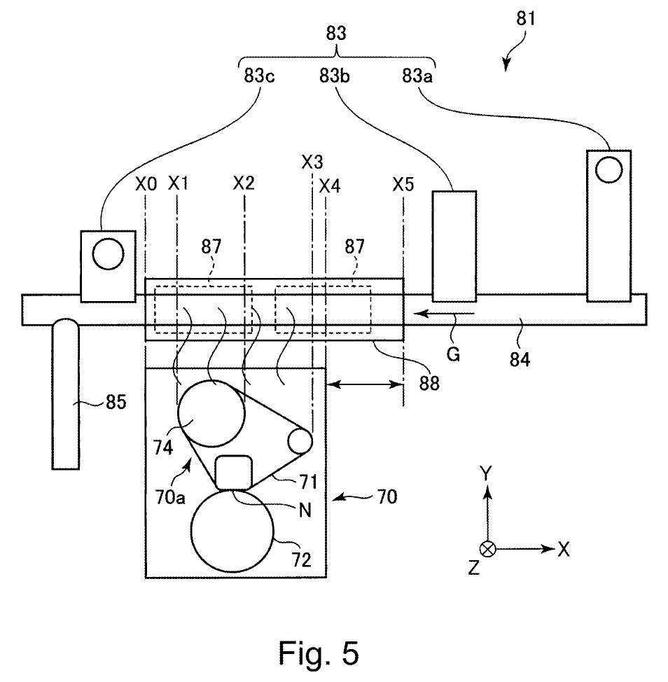

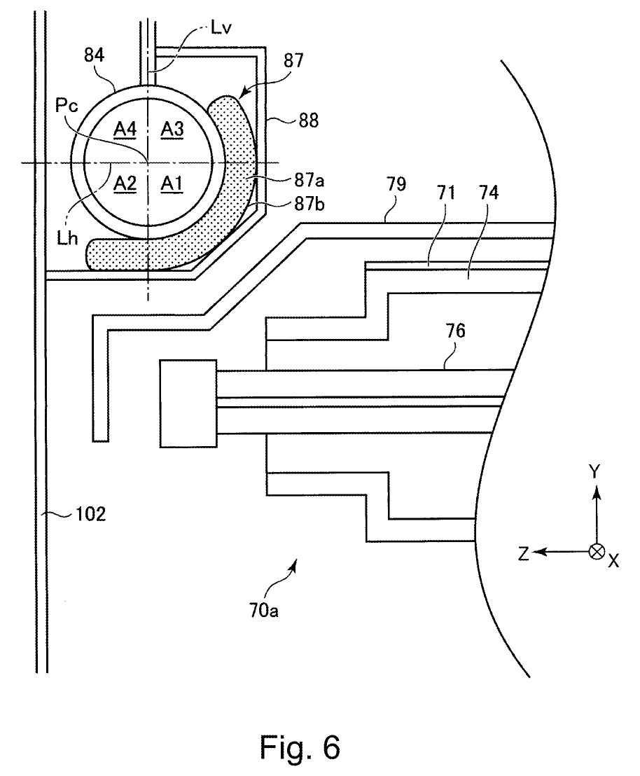

Next, a temperature rise suppression constitution of the collecting pipe passage 81 in this embodiment will be described using FIG. 5 and FIG. 6. FIG. 6 is an X-Y sectional view passing through the fixing belt 71, showing a relative position relationship between the collecting pipe passage 81 and the fixing device 70 in this embodiment. Further, FIG. 6 is a Y-Z sectional view passing through the fixing belt 71, showing a relative position relationship between the merging pipe passage 84 of the collecting pipe passage 81 and the fixing device 70 in this embodiment.

Incidentally, the X-Y cross section shown in FIG. 5 is an example of a first plane (i.e., a cross section substantially perpendicular to a rotational axis of the rotatable heating member (the fixing belt 71 in this embodiment) substantially perpendicular to a surface of the rotatable heating member (the fixing belt 71 in this embodiment). Further, the X axis direction (i.e., the left-right direction) is an example of a first direction which is the horizontal direction in the above-described first plane. Further, the A axis direction (i.e., front-rear direction, the widthwise direction of rotatable heating member (fixing belt 71 in this embodiment) is an example of a second direction which is a direction perpendicular to the above-described first plane. Further, the Y-Z cross section shown in FIG. 6 is an example of a vertical plane passing through the rotatable heating member (fixing belt 71 in this embodiment) and perpendicular to the above-described first plane. FIG. 6 specifically shows a cross section cut along the vertical plane passing through the rotational axis of the heating roller 74 for heating the fixing belt 71.

As shown in FIG. 5, in this embodiment, the heating unit 70a of the fixing device 70 and the branch pipe passage 83 of the collecting pipe passage 81 are disposed in a positional relationship such that these members do not convey with each other with respect to the left-right direction (X axis direction, first direction). Specifically, in this embodiment, the fixing belt 71 and the branch pipe passage 83 of the collecting pipe passage 81 are disposed so that these members do not overlap with each other with respect to the left-right direction (X axis direction, first direction). By this, in the case where heat generated by the heating unit 70a is raised along the gravitation direction by natural convection, warming of the branch pipe passages 83 (83a, 83b, 83c) is suppressed. As a result, the toner is suppressed from being deposited and fused on an inner wall of the branch pipe passages 83 in which the residual toner is not forcedly conveyed by the conveying member 86.

Further, as shown in FIG. 6, in this embodiment, the merging pipe passage 84 and the heating unit 70a of the fixing device 70 are disposed in a positional relationship such that these members do not overlap with each other with respect to the front-rear direction (Z axis direction, second direction, widthwise direction of rotatable heating member (fixing belt 71 in this embodiment). Specifically, in this embodiment, the merging pipe passage 84 and the fixing belt 71 are disposed in a positional relationship such that these members do not overlap with each other with respect to the front-rear direction (Z axis direction, second direction, widthwise direction of rotatable heating member (fixing belt 71 in this embodiment)). In other words, in this embodiment, the merging pipe passage 84 and the heating roller 74 for heating the fixing belt 71 are disposed in a positional relationship such that these members do not overlap with each other with respect to the front-rear direction (Z axis direction, second direction, widthwise direction of rotatable heating member (fixing belt 71 in this embodiment). By this, the influence of the heat received from the fixing belt 71 and the heating roller 74 by the residual toner inside the merging pipe passage 84 is reduced as little as possible.

Further, in this embodiment, the collecting pipe passage 81 (branch pipe passages 83 (83a, 83b, 83c) and merging pipe passage 84) is positioned above the heating unit 70a (specifically, fixing belt 71) of the fixing device 70 in the gravitation direction. Further, the collecting pipe passage 81 (branch pipe passages 83 (83a, 83b, 83c) and merging pipe passage 84) is disposed in a position where the collecting pipe passage does not overlap with the heating unit 70a (specifically, fixing belt 71) with respect to the horizontal plane direction (front-rear direction). Incidentally, an expression that a first element and a second element do not overlap with each other with respect to the horizontal plane refers to, in other words, that in the case where each of the first element and the second element is projected on the horizontal plane, a region in which the first element is projected and a region in which the second element is projected do not overlap with each other. Further, in this embodiment, the merging pipe passage 84 extends in the left-right direction (X axis direction, first direction) so as to cross over the heating unit 70a (specifically, fixing belt 71), but the branch pipe passages 83 (83a, 83b, 83c) are disposed in positions where these branch pipe passages 83 do not overlap with the heating unit 70a (specifically, fixing belt 71). In this embodiment, in the left-right direction (X axis direction, first direction), the heating unit 70a (specifically, fixing belt 71) is positioned between the second branch pipe passage 83b and the third branch pipe passage 83c. Here, in this embodiment, with respect to the front-rear direction (Z axis direction, second direction, widthwise direction of rotatable heating member (fixing belt 71 in this embodiment)), the collecting pipe passage 81 (particularly, merging pipe passage 84) and the fixing cover 79 of the fixing device 70 overlap with each other. However, with respect to the front-rear direction (Z axis direction, second direction, widthwise direction of rotatable heating member (fixing belt 71 in this embodiment)), the collecting pipe passage 81 (particularly, merging pipe passage 84) and the heating unit 70a (specifically, fixing belt 71) do not overlap with each other. Incidentally, the collecting pipe passage 81 may also be disposed in a position where the collecting pipe passage 81 does not overlap with the fixing cover 79 of the fixing device 70 with respect to the front-rear direction.

However, there is a possibility that deposition and fusion of the toner in an amount such that it becomes difficult to scrape off (or loosen (collapse)) the toner by the conveying member 86 occur even in the merging pipe passage 84 in which the conveying member 86 is provided. For example, when the image forming apparatus 100 is downsized, the collecting pipe passage 81 is disposed in a range of a distance in which the collecting pipe passage 81 is influenced by heat from the fixing device 70, and therefore, the possibility becomes high. Further, even in the case where a duct or a fan which are for discharging heat generated from the fixing device 70 of the image forming apparatus 100 is provided, for example, in the case where a power source of the image forming apparatus 100 is turned off immediately after a print job is executed or in the like case, a heat-discharging fan is stopped in a state in which ambient air in a periphery of the fixing device 70 accumulates heat by operation of the fixing device 70 in the print job. In such a case, the collecting pipe passage 81 is warmed, so that there is a possibility that fusion of the toner in the collecting pipe passage 81 occurs.

Therefore, in this embodiment, as shown in FIGS. 5 and 6, with respect to the left-right direction (X axis direction, first direction), in at least a part of a region overlapping with the heating unit 70a of the fixing device 70, a heat storage member 87 provided with a latent heat storage material 87a and a metal cover 88 which is a cover member mode of metal are provided outside the merging pipe passage 84. The heat storage member 87 and the metal cover 88 are disposed so as to be superposed in this order from a near side to a far side of an outer wall of the merging pipe passage 84.

As shown in FIG. 5, specifically, with respect to the left-right direction, in at least a part of the region (region between a position of X1 and a position of X3) overlapping with the fixing belt 71, the heat storage member 87 and the metal cover 88 are provided outside the merging pipe passage 84. That is, the rotatable heating member (fixing belt 71 in this embodiment), the metal cover 88, and the latent heat storage material 87a are disposed in positions crossing at least one plane (for example, a plane existing in the position of X1 in FIG. 5, a plane existing in a position of X2 in FIG. 5, a plane existing in the position of X3 in FIG. 5) of planes (for example, the plane existing in the position of X1 in FIG. 5, the plane existing in the position of X2 in FIG. 5, the plane existing in the position of X3 in FIG. 5, a plane existing in a position of X4 in FIG. 5, a plane existing in a position of X5 in FIG. 5) which is parallel to the widthwise direction (Z axis direction) of the rotatable heating member (fixing belt 71 in this embodiment) and parallel to the vertical direction (Y axis direction). Particularly, with respect to the left-right direction, in at least a part of a region (region between the position of X2 in FIG. 5 and the position of X2 in FIG. 5) overlapping with the heating roller 74, the heat storage member 87 and the metal cover 88 are provided outside the merging pipe passage 84. In this embodiment, the metal cover 88 is disposed over a range including a whole area of the region overlapping with the fixing belt 71 with respect to the left-right direction. Further, in this embodiment, the heat storage member 87 is disposed over a range which is a range in at least a part of the region overlapping with the fixing belt 71 with respect to the left-right direction and which includes a whole area of the region overlapping with the heating roller 74 with respect to the left-right direction.

Further, as shown in FIG. 6, in the Y-Z cross section passing through the fixing belt 71, the merging pipe passage 84 is divided by a vertical line Lv passing through a center Pc of the merging pipe passage 84 and a horizontal line Lh passing through the center Pc of the merging pipe passage 84. Further, a region (area) on a fixing belt 71 side (front side) than the vertical line Lv and on a lower side than the horizontal line Lh is defined as a first region (area) A1. In addition, a region on an opposite side (rear side) from the fixing belt 71 with respect to the vertical line Lv and on an upper side than the horizontal line Lh is defined as a second region A2. In addition, a region on the fixing belt 71 side (front side) than the vertical line Lv and on the upper side than the horizontal line Lh is defined as a third region A3. In addition, a region on the opposite side (rear side) from the fixing belt 71 with respect to the vertical line Lv and on the upper side than the horizontal line Lh is defined as a fourth region A4. Incidentally, the vertical line Lv and the horizontal line Vh each between adjacent regions in the first to fourth regions A1 to A4 can be regarded as belonging to either one of the adjacent regions. At this time, the heat storage member 87 and the metal cover 88 are provided so as to cover at least a part of the outer wall of the merging pipe passage 84 in the first region A1 and may preferably be provided so as to cover a whole area of the outer wall of the merging pipe passage 84 in the first region A1. By this, in a range including a rectilinear line connecting the merging pipe passage 84 and the heating unit 70a (specifically fixing belt 71 (particularly, heating roller 74)) of the fixing device 70 in a shortest distance, an effect of shielding transmission of heat from the fixing device 70 to the merging pipe passage 84 can be achieved. In addition, the heat storage member 87 and the metal cover 88 may preferably be provided continuously from the first region A1 so as to cover at least a part of the outer wall of the merging pipe passage 84 in at least one of the second region A2 and the third region A3. By this, the effect of shielding the transmission of the heat from the fixing device 70 to the merging pipe passage 84 can be improved. In this embodiment, each of the heat storage member 87 and the metal cover 88 is provided so as to cover a whole area of the outer wall of the merging pipe passage 84 in the first region A1, and in addition, is provided continuously from the first region A1 so as to cover at least a part of the outer wall of the merging pipe passage 84 in each of the second region A2 and the third region A3.

Incidentally, the outer wall of the merging pipe passage 84 and the heat storage member 87 may be contacted to each other in at least a part of the region or may also be separated from each other in a whole area of the region. The heat storage member 87 and the metal cover 88 may be contacted to each other in at least a part of the region or may also be separated from each other in a whole area of the region. The metal cover 88 and the fixing cover 79 may preferably be separated from each other in a whole area of the region, but may also be contacted to each other at least a part of the region.

The latent heat storage material 87a constituting the heat storage member 87 is a heat storage material consisting of a material such as paraffin, for example, and also acts as a heat absorbing material by utilizing thermal energy necessary for a phase change from a solid to a liquid. At a temperature near a normal temperature (for example, 25°C) in a use environment of the image forming apparatus 100, the latent heat storage material 87a is in a solid state. When heat is applied to the latent heat storage material 87a in this solid state, at the temperature near the normal temperature, the temperature of the latent heat storage material 87a simply rises, but temperature rise is temporarily settled at a temperature near a melting point of the latent heat storage material 87a, and then the latent heat storage material 87a starts a phase change to the liquid state. During the phase change to the liquid state, the latent heat storage material 87a uses the applied thermal energy for the phase change, and therefore, until the phase change to the liquid occurs substantially completely, the temperature rise of the latent heat storage material 87a itself can be suppressed at a temperature near the melting point. By this, for example, even after the power source of the image forming apparatus 100 is turned off, the heat generated in the fixing device 70 is absorbed by the latent heat storage material 87a, so that it is possible to suppress excessive temperature rise of the collecting pipe passage 81.

In this embodiment, the heat storage member 87 is prepared in the following manner. As the latent heat storage material 87a, paraffin which becomes gel-like in a solid state is filled inside a heat storage material container 87b of a thin sheet prepared by PET (polyethylene terephthalate) as a resin material, and then a filling opening (not shown) of the heat storage material container 87b is sealed with a heat seal. In this embodiment, the melting point of the latent heat storage material 87a is about 50°C.

Further, in this embodiment, the heat storage member 87 is mounted to an outside of the collecting pipe passage 81 (merging pipe passage 84) in the following manner. When the heat storage member 87 is mounted to the collecting pipe passage 81, the heat storage member 87 is put in a liquid state in advance by a heating means such as a heat gun. Then, the heat storage member 87 is inserted, from the outside of the heat storage member 87 by the metal cover 88, between the collecting pipe passage 81 and the metal cover 88 while a shape of the heat storage member 87 is caused to follow a shape of a cylindrical outer wall of the collecting pipe passage 81, so that the heat storage member 87 is fixed to the collecting pipe passage 81. By this, even in a normal temperature environment, in a gap (space) between the collecting pipe passage 81 and the metal cover 88, the heat storage member 87 can be disposed outside the collecting pipe passage 81 in a state in which the shape of the heat storage member 87 follows the shape of the outer wall of the collecting pipe passage 81.

The melting point of the latent heat storage material 87a may desirably be a temperature higher than the normal temperature (for example, 25°C) of an assumed use environment of the image forming apparatus 100 and lower than a temperature at which the temperature of the latent heat storage material 87a arrives until the temperature of the collecting pipe passage 81 arrives at a temperature such that the fusion of the toner possibly causing clogging of the residual toner can occur. The melting point of the latent heat storage material 87a can be appropriately set depending on a characteristic or the like of the toner used in the image forming apparatus 100. It can be said that the melting point of the latent heat storage material 87a becomes an index thereof when the melting point is approximately not more than a softening point (for example, 90 ~ 160°C) of the toner or a glass transition point (for example, 50 ~ 70°C). The melting point of the latent heat storage material 87a can be made about 30 ~ 100°C and may preferably be about 40 ~ 90°C. Incidentally, as regards numerical value ranges "~" means a range including numerical values before and after "~". As an organic latent heat storage material, a paraffin-based one, a fatty acid-based one, and a polyethylene glycol-based one are known, and as an inorganic latent heat storage material, a hydrated salt-based one and a metal-based one are known. For example, as the latent heat storage material 87a, an organic paraffin, and inorganic hydrates such as sodium sulfate decahydrate, sodium acetate trihydrate, and sodium thiosulfate pentahydrate, and the like can be used.

The metal cover 88 is a cover member prepared by a sufficiently good thermal conductive metal such as an aluminum material (aluminum or aluminum alloy) and provided so as to cover the collecting pipe passage 81 (merging pipe passage 84) for the fixing device 70. In this embodiment, the metal cover 88 is formed of the aluminum alloy. The metal cover 88 is adjacent and mounted to the heat storage member 87 on the fixing device 70 side. By preparing the cover member with metal, radiant heat from the fixing device 70 is reflected, so that the influence of heat received by the heat storage member 87 and the collecting pipe passage 81 which are disposed inside the cover member can be suppressed. Further, by preparing the cover member with metal, the heat generated in the fixing device 70 can be conducted and diffused to the entire cover member, so that it is possible to suppress that the heat storage member 87 and the collecting pipe passage 81 which are provided inside the cover member are locally increased in temperature. For that reason, the metal cover 88 can be distributed over a wider range with extension thereto to a more distant position as viewed from the fixing device 70, and therefore, the above-described constitution is a desirable constitution. In this embodiment, the metal cover 88 is extended to a right side than the fixing device 70 is in the left-right direction so that a position (position of X5 in FIG. 5) of a right-side end portion of the metal cover 88 is disposed on a right side than a position (position of X4 in FIG. 5) of a right-side end portion of the fixing device 70. For example, in this embodiment, in the left-right direction, the position (position of X5 in FIG. 5)of the right-side end portion of the metal cover 88 is disposed in a position of 80 mm rightward from the position (position of X4 in FIG. 5) of the right-side end portion of the fixing device 70. In this embodiment, the right side of the fixing device 70 in the left-right direction is an upstream side of the conveying direction G of the residual toner, inside the merging pipe passage 84, conveyed by the conveying member 86. Further, in this embodiment, in the left-right direction, a position of a left-side end portion of the metal cover 88 is disposed in substantially the same position as a position (position of X0 in FIG. 5) of a left-side end portion of the fixing device 70, but the left-side end portion the metal cover 88 may also be extended to a left side than the fixing device 70 is. Incidentally, in this embodiment, in the left-right direction, each of the right-side end portion and the left-side end portion of the fixing device 70 is an end portion of the fixing cover 79.

Further, the metal cover 88 may preferably contact another metal member. By this, a good temperature rise suppressing effect can be obtained. For example, as shown in FIG. 6, the metal cover 88 may desirably be contacted and fixed to a member made of metal sufficiently large in heat capacity, such as a frame 102 made of metal or the like of the apparatus main body 101 of the image forming apparatus 100. The frame 102 may support at least one of at least a part of the collecting pipe passage 81 and at least a part of the fixing device 70. The metal cover 88 can be fixed to the frame 102 or the like by an arbitrary fixing means such as fastening or welding.

Incidentally, in this embodiment, inside the metal cover 88 (on the collecting pipe passage 81 side), two heat storage members 87 and disposed along the left-right direction, but a single large heat storage member 87 may also be disposed. Further, the heat storage member 87 may be divided into three portions.

Further, in this embodiment, the metal cover 88 is constituted by a single member, but may also be constituted by a plurality of cover members. In the case where the metal cover 88 is constituted by the plurality of cover members, adjacent cover members may preferably connected to each other by an arbitrary fixing means such as fastening.

Thus, in this embodiment, the image forming apparatus 100 includes the image forming portion 1 or forming the image on the recording material S and provided with the discharging portion (drum cleaning device 6, belt cleaning device 7, developing device 4) for discharging the residual toner; the fixing device 70 for fixing the toner image, formed by the image forming position, on the recording material S and provided with the rotatable heating member (fixing belt) 71 for imparting heat to the recording material S; the collecting pipe passage 81 passing through the residual toner discharged from the discharging portion, wherein when the plane substantially perpendicular to the surface of the rotatable heating member 71 is the first plane (X-Y cross section) and the horizontal direction in the first plane is the first direction (left-right direction, X axis direction), at least a part of the collecting pipe passage 81 is disposed in the position overlapping with the rotatable heating member 71 with respect to the first direction; the metal cover member 88 provided between the collecting pipe passage 81 and the fixing device 70 in at least a part of the region overlapping with the rotatable heating member 71 with respect to the first direction; and the heat storage member 87 provided between the cover member 88 and the collecting pipe passage 81 in at least the part of the region overlapping with the rotatable heating member 71 with respect to the first direction and provided with the latent heat storage material 87a. Further, in this embodiment, when the direction perpendicular to the first plane is the second direction (front-rear direction, widthwise direction of rotatable heating member (fixing belt 71 in this embodiment)), the collecting pipe passage 81 is disposed in the position not overlapping with the rotatable heating member 71 with respect to the second direction. Further, in this embodiment, the collecting pipe passage 81 is disposed above the rotatable heating member 71. Further, in this embodiment, the image forming portion P includes the plurality of discharging portions, and the collecting pipe passage 81 includes the plurality of branch pipe passages 83 (83a, 83b, 83c) which are connected to the plurality of discharging portions, respectively, and which are each for receiving the residual toner discharged from the associated one of the plurality of discharging portions; and the merging pipe passage 84 connected to the plurality of branch pipe passages 83 and for receiving the residual toner from each of the plurality of branch pipe passages 83, wherein the plurality of branch pipe passages 83 are disposed in the positions not overlapping with the rotatable heating member 71 with respect to the first direction, wherein at least a part of the merging pipe passage 84 is disposed in the position overlapping with the rotatable heating member 71 with respect to the first direction, and wherein the cover member 88 and the heat storage member 87 are provided between the fixing device 70 and the merging pipe passage 84. Further, in this embodiment, in the vertical plane passing through the rotatable heating member 7 and perpendicular to the first plane, the merging pipe passage 84 is divided by the vertical line Lv passing through the center of the merging pipe passage 84 and the horizontal line Lh passing through the center of the merging pipe passage 84, and when the region on the rotatable heating member side than the vertical line Lv and on the lower side than the horizontal line is the first region A1, the cover member 88 and the heat storage member 87 are provided so as to be positioned outside the merging pipe passage 84 in at least the first region A1. Further, when the region on the opposite side from the rotatable heating member 71 with respect to the vertical line Lv and on the lower side than the horizontal line Lh is the second region A2 and when the region on the rotatable heating member 71 side with respect to the vertical line Lv and on the upper side than the horizontal line Lh is the third region A3, the cover member 88 and the heat storage member 87 may preferably be provided so as to be positioned continuously to an outside of the merging pipe passage 84 in at least one of the second region A2 and the third region A3.

Further, in this embodiment, the residual toner received in each of the plurality of branch pipe passages 83 drops inside the associated branch pipe passage 83, the image forming apparatus 100 includes the conveying means (conveying member) 86 for conveying the residual toner inside the merging pipe passage 84, and the residual toner received in the merging pipe passage 84 is conveyed inside the merging pipe passage 84 by the conveying means 86. Further, in this embodiment, the cover member 88 is formed of the aluminum alloy. Further, in this embodiment, in this embodiment, the cover member 88 is provided continuously over a range wider than a region overlapping with the rotatable heating member 71 with respect to the above-described first direction. Further, in this embodiment, the fixing device 70 includes the casing (fixing cover) 79 for covering the rotatable heating member 71, and in the first direction, at least one end portion of the cover member 88 is positioned in a position spaced from the rotatable heating member 71 toward an opposite side to the end portion on the above-described one end portion side of the cover member 88 of the opposite end portions of the casing 79. Further, in this embodiment, the image forming apparatus 100 includes the frame 102 made of metal, and at least a part of the cover member 88 contacts the frame 102. Further, in this embodiment, the frame 102 supports at least one of at least a part of the collecting pipe passage 81 and at least a part of the fixing device 70. Further, the image forming portion P includes the photosensitive member (photosensitive drum) 1 on which the toner image is formed, the intermediary transfer belt 30 onto which the toner image is transferred from the photosensitive member 1, the first cleaning provided (drum cleaning device) 6 for collecting the residual toner from the photosensitive member 1, and the second cleaning device (belt cleaning device) 7 for collecting the residual toner from the intermediary transfer belt 30, wherein the plurality of discharging portions include the first cleaning device 6 and the second cleaning device 7. Further, in this embodiment, the image forming portion P includes the developing device 4 for forming the toner image on the photosensitive member 1 by supplying the toner to the photosensitive member 1, and the plurality of discharging portions includes the developing device 4.

Incidentally, the collecting pipe passage 81 may also be constituted so that the residual toner discharged through a single discharging portion passes through the collecting pipe passage 81. For example, the image forming portion P includes the photosensitive member 1 on which the toner image is formed, the intermediary transfer belt 30 onto which the toner image is transferred from the photosensitive member 1, the first cleaning device 6 for collecting the residual toner from the photosensitive member 1, the second cleaning device 7 for cleaning the residual toner from the intermediary transfer belt 7, and the developing device 4 for forming the toner image on the photosensitive member by supplying the toner to the photosensitive member 1, wherein the discharging portion may be at least one of the first cleaning device 6, the second cleaning device 7, and the developing device 4.

As described above, according to this embodiment, even in the case where a distance between the fixing device 70 and the collecting pipe passage 81 is short, fusion of the toner in the collecting pipe passage 81 is suppressed, so that clogging of the residual toner inside the collecting pipe passage 81 can be suppressed. For example, according to this embodiment, the periphery of the collecting pipe passage 81 is covered with a duct, so that even when a mechanism for forcedly cooling the collecting pipe passage 81 by a fan, or the like is not provided, it is possible to suppress the clogging of the residual toner inside the collecting pipe passage 81. For that reason, it is possible to achieve cost reduction and downsizing (suppression of an increase in cost and upsizing) of the image forming apparatus 100. Further, for example, even in the case where the image forming apparatus 100 is provided with the duct and the fan for discharging heat generated from the fixing device 70, the fan is stopped in the case where the power source of the image forming apparatus 100 is turned off immediately after the print job is executed or in the case where power failure and a jam (paper jam) occurred, or in the like case. According to this embodiment, even in such cases, it is possible to suppress the influence of the heat received by the collecting pipe passage 81. Further, according to this embodiment, the influence of the heat on the collecting pipe passage 81 can be suppressed, and therefore, it is possible to achieve shortening of a time until the fan is stopped after the image formation is ended.

### Other embodiments

In the above-described embodiments, the image forming apparatus is the monochromatic image forming apparatus including only one photosensitive member, but the present disclosure is also applicable to, for example, a color image forming apparatus capable of forming a full-color image. In this case, a constitution of a tandem type in which a plurality of image forming units are provided along an image forming surface of the intermediary transfer belt in the above-described embodiment can be employed. Each of the image forming units is constituted by including, for example, similarly as in the above-described embodiment, the photosensitive member and process means (charging means, exposure means, developing means, photosensitive member cleaning means) actable on the photosensitive member. Here, the image forming apparatus in the above-described embodiment may also be a monochromatic image forming apparatus constituted by leaving parts and units, necessary to form a black (monochromatic image), from parts and units in such an image forming apparatus of the tandem type. That is, the image forming apparatus of the above-described embodiment may have a constitution from which elements necessary to form images of yellow, magenta, and cyan in the image forming apparatus of the tandem type are removed and in which elements necessary to form the black image is left. The color image forming apparatus and the monochromatic image forming apparatus are substantially the same in a relative position of the primary transfer portion for black, a relative position of the secondary transfer portion for black, and a relative position of the residual toner container for black. The present disclosure can be said to be easily applied to such a monochromatic image forming apparatus.

Further, in the above-described embodiment, the cleaning device was described as one for collecting the transfer residual toner from the image bearing member, but can also collect a toner image (toner patch) for control.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application Nos. 2025-067787, filed on April 16, 2025, and 2026-052518, filed on March 26, 2026, which are hereby incorporated by reference herein in their entirety.

What is claimed is:

1. An image forming apparatus comprising:
an image forming portion including at least one discharging portion for discharging residual toner and configured to form a toner image on a recording material;
a fixing device including a rotatable heating member for imparting heat to the recording material and configured to fix, to the recording material, the toner image formed by the image forming portion;
a pipe passage through which the residual toner discharged from the at least one discharging portion passes;
a cover member provided between the pipe passage and the fixing device, and made of metal; and
a latent heat storage material provided between the cover member and the pipe passage,
wherein the pipe passage is provided above the rotatable heating member in a vertical direction, and
wherein the rotatable heating member, the cover member, and the latent heat storage material are disposed in positions crossing at least one plane of planes parallel to a widthwise direction of the rotatable heating member and parallel to the vertical direction.

2. The image forming apparatus according to claim 1, further comprising:
a further latent heat storage material provided between the cover member and the pipe passage,
wherein the rotatable heating member, the cover member, and the further latent heat storage material are disposed in positions crossing at least one plane of planes parallel to the widthwise direction of the rotatable heating member and parallel to the vertical direction.

3. The image forming apparatus according to claim 1, wherein the pipe passage is disposed in a position where the pipe passage does not overlap with the rotatable heating member with respect to the widthwise direction of the rotatable heating member.

4. The image forming apparatus according to claim 1, wherein the fixing device further includes a casing for covering the rotatable heating member, and
wherein the pipe passage is disposed in a position where the pipe passage overlaps with the casing with respect to the widthwise direction of the rotatable heating member.

5. The image forming apparatus according to claim 1, wherein in a cross section perpendicular to a rotational axis of the rotatable heating member, the cover member is provided over a range wider than a region in which the cover member overlaps with the rotatable heating member with respect to a horizontal direction.

6. The image forming apparatus according to claim 1, further comprising:
a branch pipe passage connected to the at least one discharging portion,
wherein the residual toner discharged from the at least one discharging portion drops inside the branch pipe passage, and
wherein the pipe passage is a merging pipe passage which is connected to the branch pipe passage and in which the residual toner dropped inside the branch pipe passage is merged.

7. The image forming apparatus according to claim 6, wherein the branch pipe passage is disposed above the rotatable heating member in the vertical direction, and
wherein in a cross section perpendicular to a rotational axis of the rotatable heating member, the branch pipe passage is disposed in a position where the branch pipe passage does not overlap with the rotatable heating member with respect to a horizontal direction.

8. The image forming apparatus according to claim 1, wherein the at least one discharging portion comprises a plurality of discharging portions,
wherein the image forming apparatus further comprises a plurality of branch pipe passages which are connected to the plurality of discharging portions, respectively, and each in which the residual toner discharged from each of the plurality of discharging portions drops inside an associated one of the plurality of branch pipe passages, and
wherein the pipe passage is a merging pipe passage which is connected to each of the plurality of branch pipe passages and in which the residual toner dropped inside each of the plurality of branch pipe passages is merged.

9. The image forming apparatus according to claim 8, wherein each of the plurality of branch pipe passages is disposed above the rotatable heating member in the vertical direction, and
wherein in a cross section perpendicular to a rotational axis of the rotatable heating member, each of the plurality of branch pipe passages is disposed in a position where the branch pipe passage does not overlap with the rotatable heating member with respect to a horizontal direction.

10. The image forming apparatus according to claim 8, wherein the plurality of branch pipe passages include at least a first branch pipe passage and a second branch pipe passage, and
wherein in a cross section perpendicular to a rotational axis of the rotatable heating member, the rotatable heating member is positioned between the first branch pipe passage and the second branch pipe passage in a horizontal direction.

11. The image forming apparatus according to claim 8, wherein the image forming portion further includes a photosensitive member on which the toner image is formed, an intermediary transfer member onto which the toner image is transferred from the photosensitive member, a first cleaning device for collecting the residual toner from the photosensitive member, and a second cleaning device for collecting the residual toner from the intermediary transfer member, and
wherein the plurality of discharging portions include a first discharging portion for discharging the residual toner from the first cleaning device and a second discharging portion for discharging the residual toner from the second cleaning device.

12. The image forming apparatus according to claim 11, wherein the image forming portion further includes a developing device for forming the toner image on the photosensitive member by supplying toner to the photosensitive member, and
wherein the plurality of discharging portions further include a third discharging portion for discharging the residual toner from the developing device.

13. The image forming apparatus according to claim 1, wherein the cover member is formed of an aluminum alloy.

14. The image forming apparatus according to claim 1, further comprising a conveying member configured to convey the residual toner inside the pipe passage.
